(19) United States
(12) Patent Application Publication
(10) Pub. No.: US 2024/0262293 A1
(43) Pub. Date: Aug. 8, 2024

(54) TRUNK FOR INSTALLATION IN UNDERCUT REGION OF VEHICLE

(71) Applicant: Atieva, Inc., Newark, CA (US)

(72) Inventors: Kang Ye, Newark, CA (US); Derek Allen, Newark, CA (US); Sam Tan, Newark, CA (US); Eric Magnus Bach, Newark, CA (US)

(21) Appl. No.: 18/561,988

(22) PCT Filed: May 6, 2022
(86) PCT No.: PCT/US2022/072157

§ 371 Date: Nov. 17, 2023

Related U.S. Application Data
(60) Provisional application No. 63/201,876, filed on May 17, 2021.

(51) Int. Cl. B60R 5/00; B29C 70/68; B29L 31/30

(52) U.S. Cl. CPC B60R 5/00; B29C 70/68; B29L 2031/30

(57) ABSTRACT

A vehicle trunk comprises: a first trunk part forming at least a first wall of the vehicle trunk, the first trunk part including a thermoplastic elastomer material, wherein the first trunk part is at least partially collapsible to facilitate installation of the vehicle trunk into an undercut region of a vehicle; and a second trunk part forming at least a second wall of the vehicle trunk, wherein the first and second trunk parts define an interior of the vehicle trunk, and wherein the second trunk part includes a fiber-reinforced polymer material.

### CROSS-REFERENCE TO RELATED APPLICATION

This application claims priority to U.S. Patent Application No. 63/201,876, filed on May 17, 2021, and entitled “TRUNK FOR INSTALLATION IN UNDERCUT REGION OF VEHICLE,” the disclosure of which is incorporated by reference herein in its entirety.

### TECHNICAL FIELD

This document relates to a trunk for installation in an undercut region of a vehicle.

### BACKGROUND

Some types of vehicles provide trunks for storing luggage or other belongings. Most of such trunks are manufactured as an integral unit having a fixed shape and size, which unit is then inserted through an opening in the vehicle for assembly. This approach does not maximize the amount of storage space available in the trunk. Attempts have been made to capture undercut space by affixing an additional trunk component to an opening in the trunk tub. However, this approach is relatively slow to install, and can be subject to leaking due to the joint between the additional trunk component and the opening.

### SUMMARY

In one aspect, a vehicle trunk comprises: a first trunk part forming at least a first wall of the vehicle trunk, the first trunk part including a thermoplastic elastomer material, wherein the first trunk part is at least partially collapsible to facilitate installation of the vehicle trunk into an undercut region of a vehicle; and a second trunk part forming at least a second wall of the vehicle trunk, wherein the first and second trunk parts define an interior of the vehicle trunk, and wherein the second trunk part includes a fiber-reinforced polymer material.

Implementations can include any or all of the following features. The second trunk part forms a closed loop that defines a main opening into the interior. The first wall of the vehicle trunk is at least one of a rear wall of the vehicle trunk or a front wall of the vehicle trunk. The first wall is configured to abut one of a structural shear wall of the vehicle, or a bumper beam of the vehicle, after the installation. The vehicle trunk further comprises a grommet in the first trunk part, the grommet formed by the thermoplastic elastomer material and extending away from the interior, the grommet configured for attaching the first trunk part to the structural shear wall or the bumper beam. The first wall of the vehicle trunk includes two walls, the two walls facing each other and positioned at opposite sides of the interior. The two walls are a rear wall of the vehicle trunk and a front wall of the vehicle trunk, respectively. The first trunk part preexists the second trunk part, and wherein the second trunk part is formed by overmolding of the fiber-reinforced polymer material onto a part of the thermoplastic elastomer material of the first trunk part. The thermoplastic elastomer material includes an opening within the part of the first trunk part, and wherein the overmolding forms a rivet joint at the opening. The part of the thermoplastic elastomer material includes an edge of the first trunk part, and wherein the part of the thermoplastic elastomer material includes a taper in a direction that is substantially perpendicular to the edge. The part of the thermoplastic elastomer material further includes a strut adjacent the edge of the first trunk part, wherein the strut extends substantially in the direction of the taper, and wherein a top of the strut extends away from the fiber-reinforced polymer material. The part of the thermoplastic elastomer material includes multiple struts adjacent the edge of the first trunk part, wherein each of the multiple struts extends substantially in the direction of the taper, wherein the thermoplastic elastomer material includes multiple openings within the part of the first trunk part, wherein the overmolding forms multiple rivet joints, each of the multiple rivet joints formed at a respective one of the multiple openings. Each of the multiple rivet joints is positioned between two adjacent struts of the multiple struts. The rivet joint comprises a head formed of the fiber-reinforced polymer material, the head positioned on an opposite side of the opening from a remainder of the fiber-reinforced polymer material. The first trunk part includes a recess in the thermoplastic elastomer material leading to the opening, and wherein the head is positioned in the recess. The second trunk part is configured for attachment of the vehicle trunk to the vehicle. The vehicle trunk is configured to be a front trunk of the vehicle. The front trunk is configured to be positioned ahead of a front motor of the vehicle. The vehicle trunk further comprises a carpet that lines the interior of the vehicle trunk. The carpet consists of a first carpet piece and a second carpet piece, at least one of the first and second carpet pieces including an undercut part. A boundary of the first and second carpet pieces is formed without adhesive and stitching. The first carpet piece forms a ridge at the boundary, and wherein the second carpet piece is held in place at least in part by an edge of the second carpet piece biasing against the ridge. The vehicle trunk further comprises adhesive positioned between the second carpet piece and at least one of the first and second trunk parts at a location other than at the boundary, wherein the edge of the second carpet piece biases against the ridge due to the adhesive being positioned between the second carpet piece and at least one of the first and second trunk parts.

### BRIEF DESCRIPTION OF DRAWINGS

FIG. 1 shows a perspective view of an example of a vehicle trunk.

FIG. 2 shows another perspective view of the vehicle trunk of FIG. 1.

FIG. 3 shows a side view of the vehicle trunk of FIG. 1.

FIG. 4 shows an example cross section of the vehicle trunk of FIG. 1.

FIG. 5 shows a rear perspective view of the vehicle trunk of FIG. 1.

FIG. 6 shows an example cross section of a vehicle front.

FIG. 7 shows another example cross section of the vehicle front of FIG. 6.

FIG. 8 shows an example of a rivet joint between trunk parts.

FIG. 9 shows an example cross section of the rivet joint of FIG. 8.

FIG. 10 shows another example cross section of the rivet joint of FIG. 8.

FIG. 11 shows another example cross section of the rivet joint of FIG. 8.

FIG. 12 shows an example cross section of a trunk part having a grommet.

FIG. 13 shows a perspective view of an example of a carpet for a vehicle trunk.

FIG. 14 shows a perspective view of an example of the carpet piece of the carpet of FIG. 13.

FIG. 15 shows a partial perspective view of the carpet piece of FIG. 14.

FIG. 16 shows an example cross section of a boundary of the carpet pieces of the carpet of FIG. 13.

FIG. 17 shows an example cross section of a portion of the carpet of FIG. 13 and the vehicle trunk of FIG. 1.

Like reference symbols in the various drawings indicate like elements.

### DETAILED DESCRIPTION

This document describes examples of systems and techniques for a trunk to be installed in an undercut region of a vehicle. The present subject matter can provide a weathertight sealed compartment that can be inserted into an undercut area. In some implementations, examples described herein can maximize packaging room to provide improved trunk luggage space, simplify the installation, and furnish an improved trunk made as a one-piece design that is water proof and dust proof. A soft material can be integrated to one or more walls of the trunk to create a bi-state soft region. The areas are collapsible to allow installation, and expandable once installed to maximize storage room per allowable packaging room. Examples described herein can create an install a jar-like trunk which has a smaller opening and a larger belly.

Examples herein refer to an item including a hard material. As used herein, a hard material includes one or more materials that can be shaped into a part of a vehicle trunk that will retain its shape also when another part of the vehicle trunk (not made of the hard material) is being deformed. The hard material can include a hard plastic material. The hard material can include a polymer resin, including, but not limited to, polypropylene. The polymer resin of the hard material can be reinforced with one or more types of fiber. Any fiber suitable for reinforcing polymer resin can be used, including, but not limited to, glass fibers. A fiber-reinforced hard material can contain any of multiple percentages of fiber, including, but not limited to, about 20-60% fiber (e.g., about 40% fiber).

Examples herein refer to an item including a soft material. As used herein, a soft material includes one or more materials that can be shaped into a part of a vehicle trunk and that after assembly can be at least partially collapsed substantially without deforming another part of the vehicle trunk (not made of the soft material). The soft material can include a soft plastic material. The soft material can include a vulcanized synthetic rubber material. The soft material can include a thermoplastic elastomer, including, but not limited to, a styrenic block copolymer, a thermoplastic polyolefin elastomer, a thermoplastic vulcanizate, a thermoplastic polyurethane, a thermoplastic copolyester, or a thermoplastic polyamide, or combinations thereof.

Examples herein refer to a part of a vehicle trunk being at least partially collapsible. As used herein, being at least partially collapsible means that a nonplanar trunk part is susceptible to being temporarily deformed into at least a more planar shape. For example, a nonplanar trunk part can have a substantially convex shape, a substantially concave shape, or a substantially convex and concave shape. Being at least partially collapsible as used herein can facilitate insertion of a vehicle trunk through an opening in a vehicle.

Examples herein refer to a front, rear, side, top, or a bottom. These and similar expressions identify things or aspects in a relative way based on an express or arbitrary notion of perspective. That is, these terms are illustrative only, used for purposes of explanation, and do not necessarily indicate the only possible position, direction, and so on.

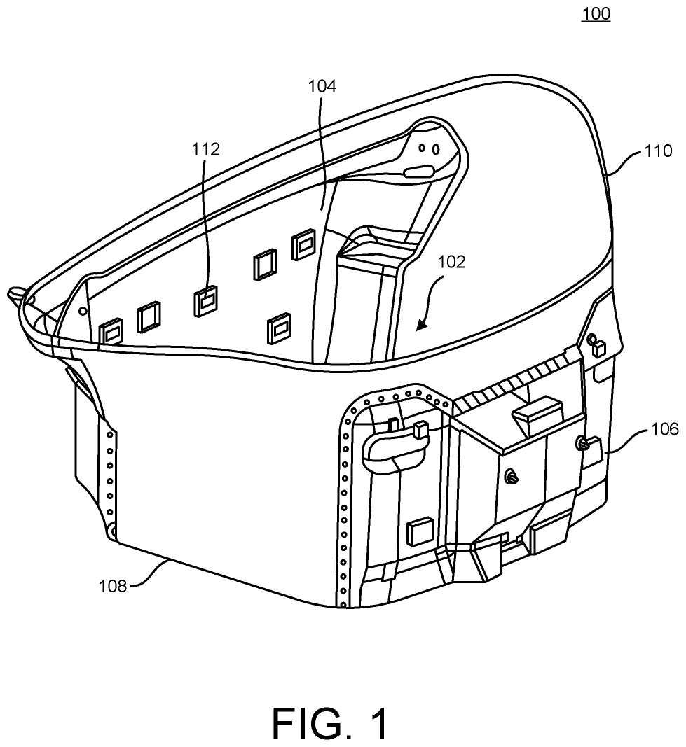

FIG. 1 shows a perspective view of an example of a vehicle trunk 100. The vehicle trunk 100 can be used with other examples described elsewhere herein. The vehicle trunk 100 has an interior 102. In some implementations, when the vehicle trunk 100 is installed in a vehicle, the interior 102 provides a space to store luggage, vehicle equipment, or other belongings. The vehicle trunk can be located outside a passenger compartment or inside the passenger compartment (e.g., in form of a glove box). The vehicle trunk 100 can be configured for installation in any suitable location of a vehicle. The vehicle trunk 100 can be installed in a front part of a vehicle (e.g., as a front trunk), or in a rear part of a vehicle (e.g., as a rear trunk), to name just two examples. A vehicle can have one or more trunks such as the vehicle trunk 100.

The vehicle trunk 100 is made of trunk parts that together define the interior 102. Here, the vehicle trunk 100 includes trunk parts 104, 106, and 108. In some implementations, the trunk parts 104 and 106 can be referred to as side portions and the trunk part 108 can be referred to as a center portion. More or fewer parts can be used. The trunk part 108 can include a rim 110 that extends around an entire opening to the interior 102. The rim 110 can form a closed loop that defines a main opening into the interior 102. Other approaches can be used.

Two or more trunk parts can be made of the same or different materials. In some implementations, at least one of the trunk parts 104 or 106 is made of a soft material. For example, the trunk parts 104 and 106 can be made of the same or different soft materials. In some implementations, the trunk part 108 can be made of a hard material. The material choice(s) can be made so that at least one of the trunk parts 104, 106, or 108 is at least partially collapsible to facilitate installation of the vehicle trunk, while the vehicle trunk 100 as a whole retains sufficient stability and strength to maintain its intended shape during use. For example, the vehicle trunk 100 can be installed into an undercut region of a vehicle.

The vehicle trunk 100 can include at least one adhesive element 112 positioned within the interior, 102, for example as will be described below.

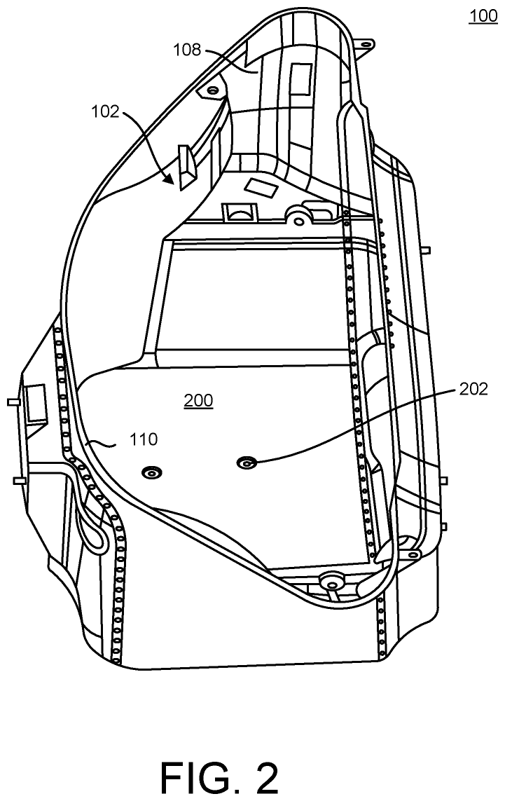

FIG. 2 shows another perspective view of the vehicle trunk 100 of FIG. 1. The vehicle trunk 100 can include a bottom wall 200 within the interior 102. In some implementations, the bottom wall 200 can be formed by the trunk part 108. For example, the bottom wall 200 can be made from a hard material. In some implementations, the vehicle trunk 100 provides a weathertight enclosure. For example, the bottom wall 200 can be formed as a single integral component without joints, and the rim 110 can be provided with an environmental seal that can be engaged by a vehicle closure.

In some implementations, the vehicle trunk 100 can include at least one fastener 202 within the interior 102. For example, the fastener(s) 202 can be positioned at the bottom wall 200 and be configured for attachment of the vehicle trunk 100 to the vehicle body or chassis.

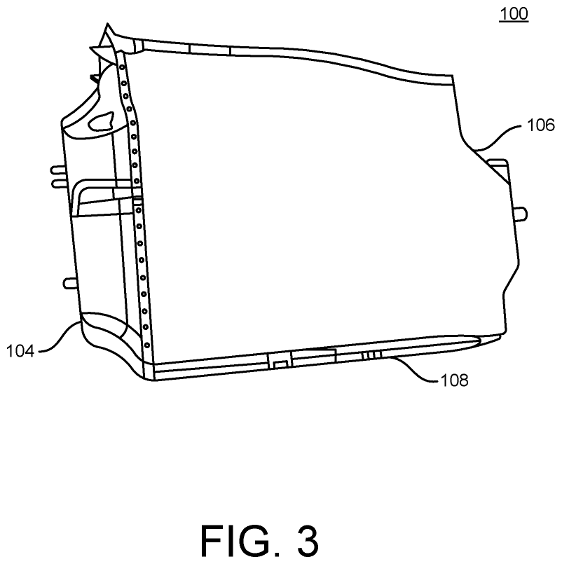

FIG. 3 shows a side view of the vehicle trunk 100 of FIG. 1. In some implementations, the trunk part 104 can be considered a real wall of the vehicle trunk 100. For example, the trunk part 104 can include a convex portion (e.g., as shown) that extends rearward in the vehicle. In some implementations, the trunk part 106 can be considered a front wall of the vehicle trunk 100. For example, the trunk part 106 can include a convex portion (e.g., as shown) that extends forward in the vehicle. Here, the trunk parts 104 and 106 face each other and are positioned at opposite sides of the interior 102 (e.g., FIG. 2).

The material choice(s) for the vehicle trunk 100 can provide at least some stackability of multiple instances of the vehicle trunk 100 before they are assembled into the vehicle(s). In some implementations, one or more trunk parts of the vehicle trunk 100 can be at least partially collapsed to allow that vehicle trunk 100 to be stacked with, or nested at least partially within another one of the vehicle trunk 100. For example, the trunk part 104 and/or 106 can be at least partially collapsed, which the trunk part 108 can remain substantially undeformed, to allow at least some stacking.

Other combinations of which trunk part(s) to have soft material(s) and which trunk part(s) to have hard material(s) can be used. In some implementations, a single trunk part is made of soft material and a remainder of the vehicle trunk 100 can be made of hard material. For example, one side wall (e.g., a front, rear, bottom, or lateral wall) can be made of soft material. In some implementations, three or more trunk parts can be made of soft material and a remainder of the vehicle trunk 100 can be made of hard material.

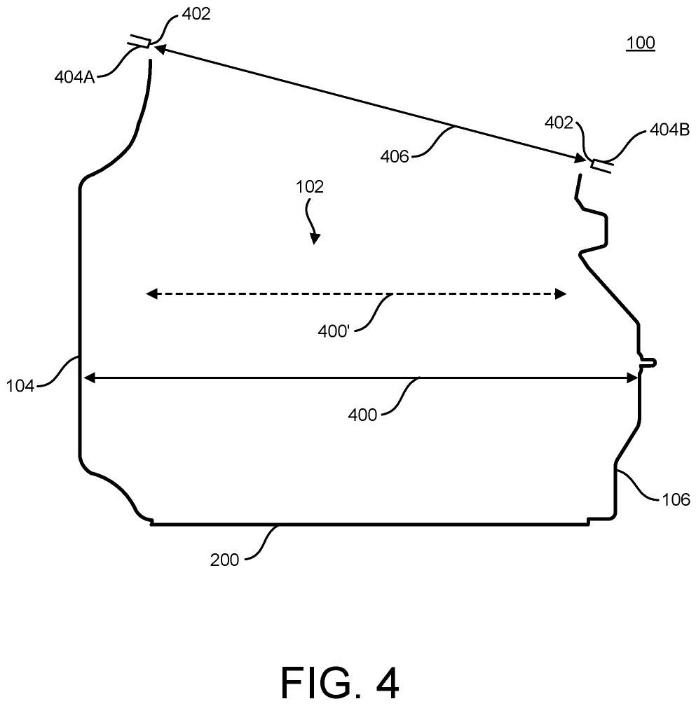

FIG. 4 shows an example cross section of the vehicle trunk 100 of FIG. 1. This illustration exemplifies how the trunk parts 104 and 106, with the bottom wall 200, define the interior 102. For example, the vehicle trunk has a dimension 400 defined as the maximum available distance between the trunk parts 104 and 106. The material choice(s) for the vehicle trunk 100 can allow the vehicle trunk 100 to be installed into an undercut region of a vehicle.

In some implementations, the vehicle trunk 100 can be installed through a vehicle opening 402 formed by vehicle structures 404A and 404B (schematically illustrated). For example, the vehicle structures 404A and 404B are part of the body of the vehicle and are made of metal. The vehicle opening 402 has a dimension 406 defined by the vehicle structures 404A and 404B. Moreover, the region inside the vehicle opening 402 is undercut, meaning that a wider space is available inside the vehicle opening 402 than the dimension 406. For example, the vehicle trunk 100 here has the dimension 400 at least somewhere within the interior 102, and the dimension 400 may be greater than the dimension 406. During assembly, the trunk part 104 and/or 106 can be at least partially collapsed due to being made of soft material, instead temporarily giving the vehicle trunk 100 a dimension 400′ which is smaller than the dimension 406. The dimension 400′ allows the vehicle trunk 100 to pass through the vehicle opening 402 during assembly. For example, this installation can involve simply dropping in the vehicle trunk 100, in its collapsed state, through the vehicle opening 402 and into its intended position.

Once inside the undercut region, the trunk part 104 and/or 106 can be undeformed into substantially the original shape(s), with the interior 102 returning to having the dimension 400, thereby making efficient use of the space available in the undercut region. The hard material of a remainder of the vehicle trunk 100 helps the vehicle trunk 100 return to its intended shape so that the interior 102 has one or more specified dimensions. For example, the ability to make efficient use of space in undercut regions can allow the vehicle trunk 100 to provide a significant improvement in available storage volume.

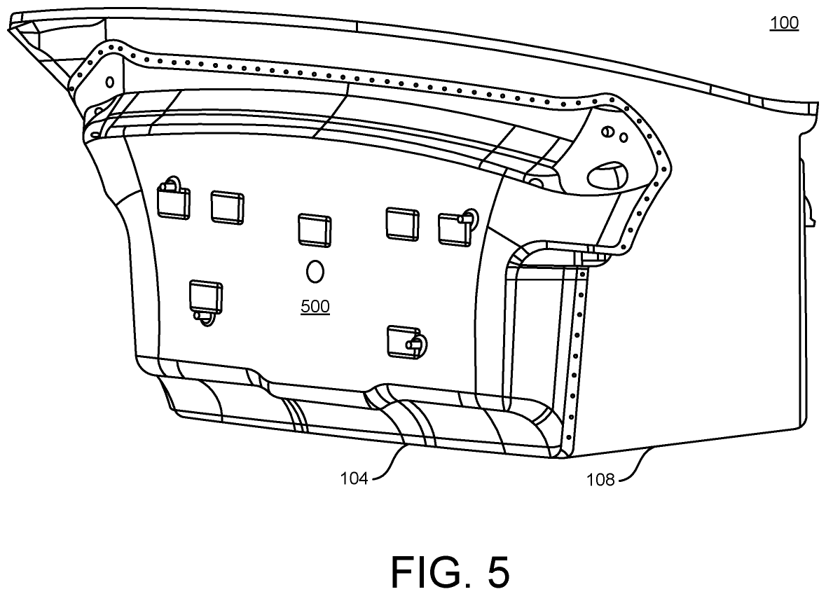

FIG. 5 shows a rear perspective view of the vehicle trunk 100 of FIG. 1. This illustration exemplifies one available shape of the trunk part 104. In some implementations, the trunk part 104 has a surface 500 that is substantially flat. In some implementations, the surface 500 forms the crown of a convex shape defined by the trunk part 104. For example, when the trunk part 104 is made of soft material, the convex shape can facilitate at least partial collapse of the trunk part 104 to facilitate installation into an undercut region. In some implementations, the surface 500 can facilitate that the vehicle trunk 100 when installed can abut a flat wall or other component of the vehicle.

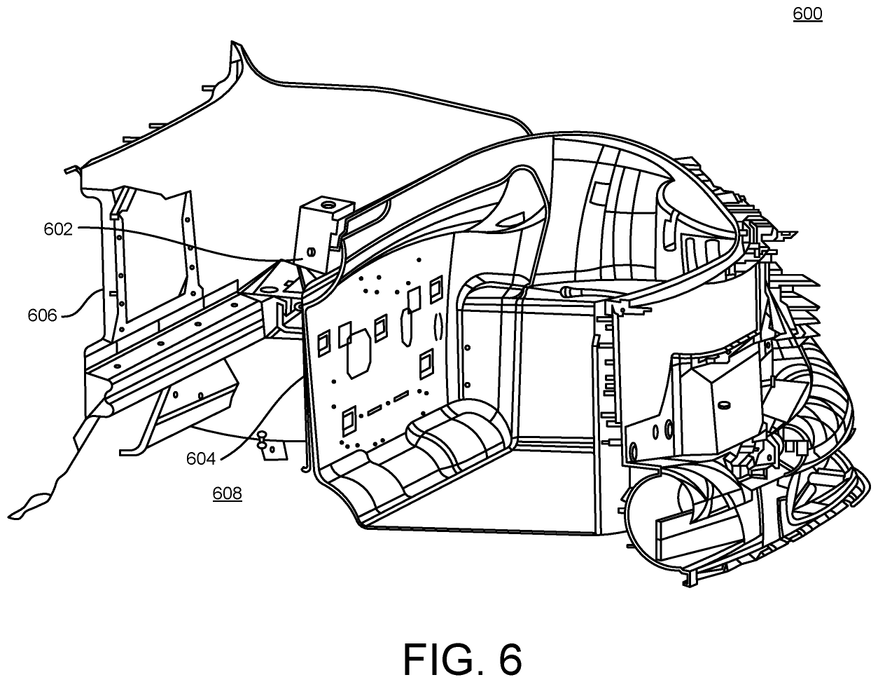

FIG. 6 shows an example cross section of a vehicle front 600. The vehicle front 600 or components thereof can be used with other examples described elsewhere herein. Here, the vehicle trunk 100 is installed in the vehicle front 600. For example, the vehicle trunk 100 can be configured to be a front trunk. Moreover, the vehicle front 600 has an undercut region inside a relatively smaller opening. For example, the opening can be at least in part defined by beam 602 of the vehicle body. The vehicle trunk 100 can be installed in such undercut region, despite nominally having one or more dimensions that exceed the size of the opening, due to at least a partial collapse of one or more trunk parts during installation.

The vehicle front 600 includes a structural shear wall 604 that is part of the vehicle body. For example, the structural shear wall 604 helps with stiffness of the vehicle. Rearward of the structural shear wall 604 is a dash panel 606. A compartment 608 is formed between the structural shear wall 604 and the dash panel 606. In some implementations, the compartment 608 can accommodate a motor of the vehicle. For example, the motor in the compartment 608 can be a front motor of the vehicle. The vehicle trunk 100 can be configured to be positioned ahead of the motor in the compartment 608. In some implementations, the trunk part 104 can be configured to abut the structural shear wall 604. For example, the trunk part 104 can have the surface 500 (FIG. 5).

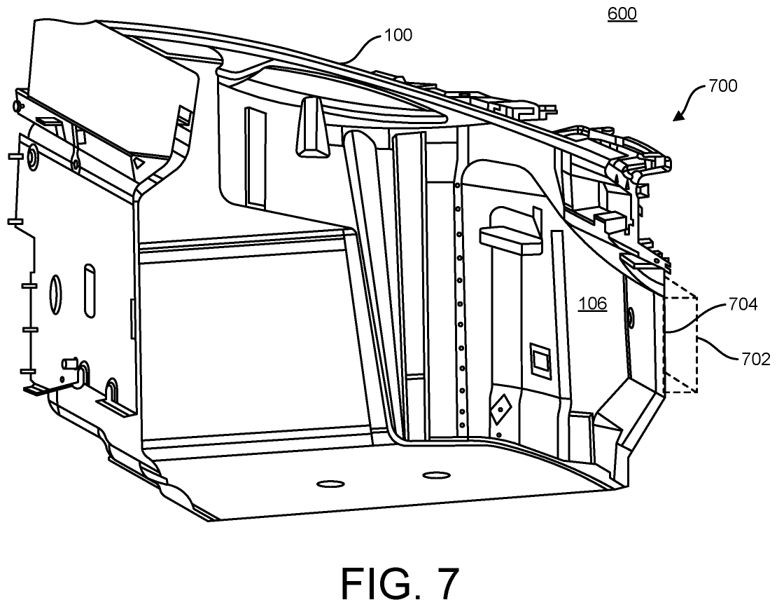

FIG. 7 shows another example cross section of the vehicle front 600 of FIG. 6. Here, the vehicle trunk 100 is installed in the vehicle front 600. The vehicle front 600 includes a vehicle front end 700 that is part of, or mounted to, the vehicle body. For example, the vehicle front end 700 is used for attaching vehicle components such as headlights and fascia, and can be used for latching a closure (e.g., a hood) in closed position. The vehicle front end 700 can be positioned aft of a bumper beam 702 (schematically illustrated). In some implementations, the vehicle front end 700 can be mounted to the bumper beam 702.

The vehicle trunk 100 can be configured to be positioned rearward of the vehicle front end 700. In some implementations, the trunk part 106 has a surface 704 that is substantially flat. In some implementations, the surface 704 forms the crown of a convex shape defined by the trunk part 106. For example, when the trunk part 106 is made of soft material, the convex shape can facilitate at least partial collapse of the trunk part 106 to facilitate installation into an undercut region. In some implementations, the surface 704 can facilitate that the vehicle trunk 100 when installed can abut a flat wall or other component of the vehicle. For example, the trunk part 106 can be configured to abut the bumper beam 702.

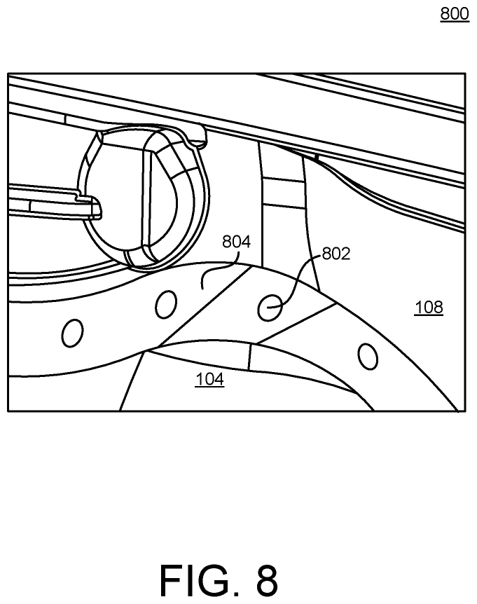

FIG. 8 shows an example of a rivet joint 800 between trunk parts. The rivet joint 800 can be used with other examples described elsewhere herein. The rivet joint 800 can be formed in the manufacturing of a vehicle trunk (e.g., the vehicle trunk 100 of FIG. 1). In some implementations, the rivet joint 800 can be formed as part of overmolding a trunk part of a hard material onto a trunk part of a soft material. For example, the trunk part 104 can be made of a soft material and can preexist the trunk part 108. The trunk part 108 can be formed by overmolding a hard material onto a part of the soft material of the trunk part 104. In some implementations, the rivet joint 800 can at least in part be based on engagement between a head 802 of the trunk part 108 and a region 804 of the trunk part 104. For example, the rivet joint 800 can ensure that the joint between the trunk part 104 and the trunk part 108 is not merely a chemical adhesion, but rather that a physical, mechanical joint is formed.

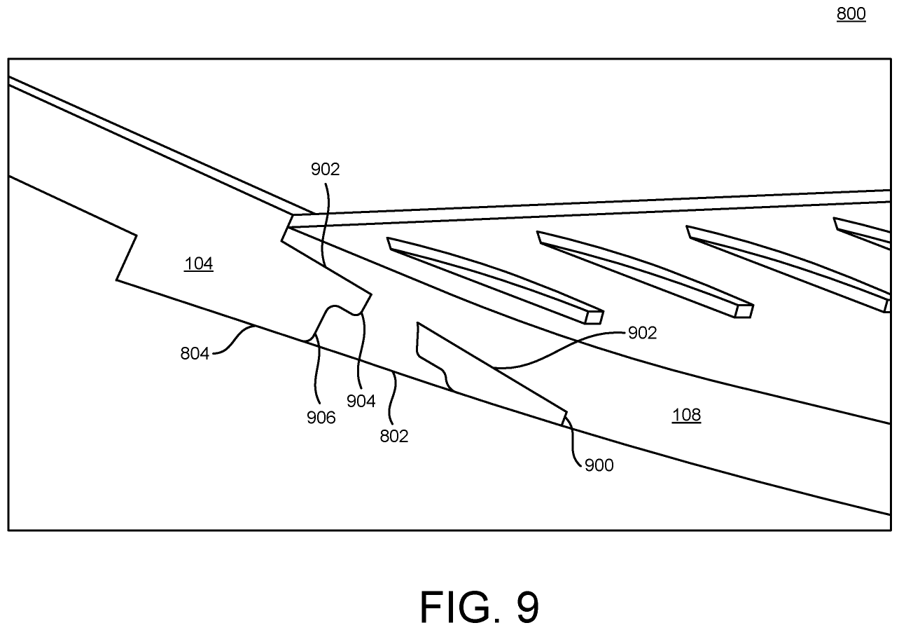

FIG. 9 shows an example cross section of the rivet joint 800 of FIG. 8. The region 804 can include an edge 900 of the trunk part 104. In the manufacturing of the trunk part 104 as a preexisting component, a taper 902 can be formed toward the edge 900. The taper 902 can be oriented in a direction that is substantially perpendicular to the edge 900. For example, the taper 902 can allow an increased surface area of the joint between the trunk parts 104 and 108.

The preexisting trunk part, here the trunk part 104, can include an opening 904. In some implementations, the molten hard material can flow through the opening 904 during the overmolding process to form the rivet joint 800. The material of the trunk part 108 can form the head 802 of the hard material in the overmolding process. The head 802 can be positioned on an opposite side of the opening 904 from a remainder of the hard material of the trunk part 108. For example, the head 802 can be formed in a recess 906 that leads to the opening 904.

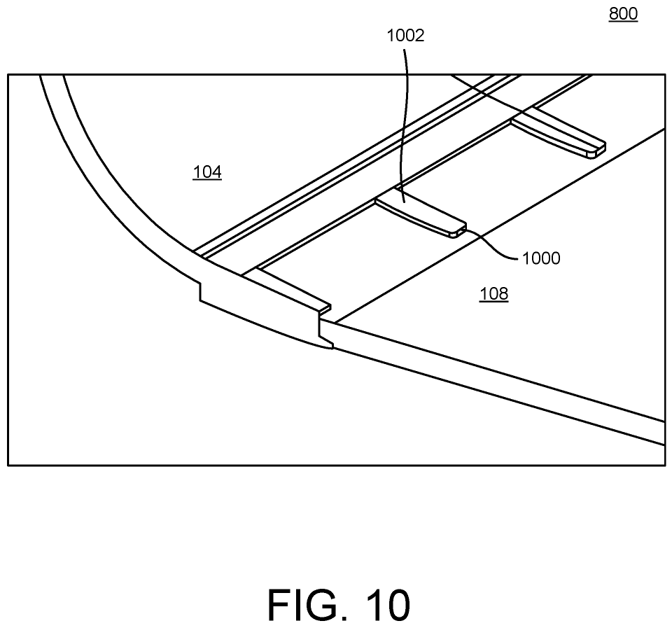

FIG. 10 shows another example cross section of the rivet joint 800 of FIG. 8. The preexisting trunk part, here the trunk part 104, can include a strut 1000 formed of the soft material. The strut 1000 can be positioned adjacent the edge 900 (FIG. 9). The strut 1000 can extend substantially in the direction of the taper 902 (FIG. 9). A top 1002 of the strut 1000 can extend away from the hard material of the trunk part 108. For example, while most of the strut 1000 is situated within the hard material of the trunk part 108, the top 1002 is not covered by the hard material. For example, the strut 1000 can increase the surface area at which the hard material and the soft material contact each other. As another example, during the overmolding process, adjacent ones of the strut 1000 can advantageously guide the flow of the molten hard material.

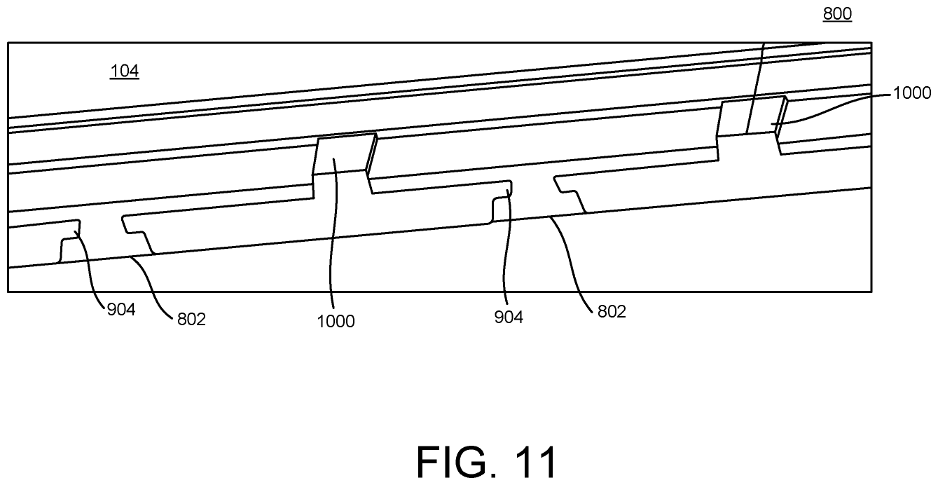

FIG. 11 shows another example cross section of the rivet joint 800 of FIG. 8. In some implementations, the preexisting trunk part, here the trunk part 104, can include multiple instances of the strut 1000 adjacent the edge 900 (FIG. 9). Each of the multiple struts 1000 can extend substantially in the direction of the taper 902 (FIG. 9). The soft material of the trunk part 104 can include multiple instances of the opening 904 within the region 804 (FIG. 8). The overmolding process can form multiple instances of the rivet joint 800. Each of the rivet joints 800 can be formed at a respective one of the multiple instances of the opening 904. Each of the multiple instances of the rivet joint 800 can be positioned between two adjacent ones of the multiple instances of the strut 1000. For example, adjacent ones of the struts 1000 can help guide the molten hard material to flow into the multiple instances of the opening 904 to form respective instances of the head 802.

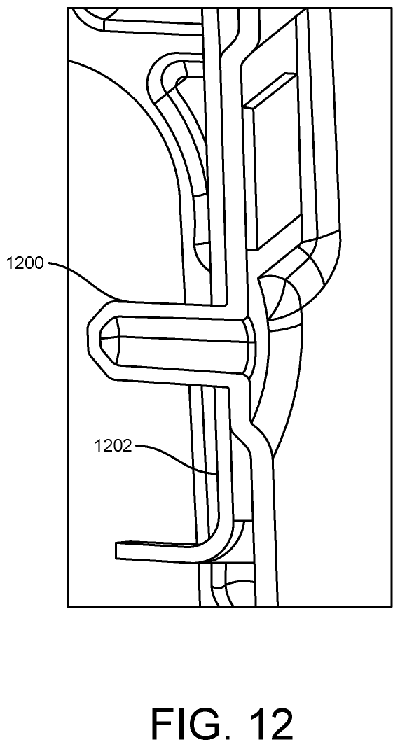

FIG. 12 shows an example cross section of a trunk part having a grommet 1200. The grommet 1200 can be used with other examples described elsewhere herein. The trunk part can be the trunk part 104 and/or 106, to name just two examples. The grommet 1200 can be formed by the soft material and can extend away from the interior 102 (e.g., FIG. 1). In some implementations, the grommet 1200 is configured for attaching the trunk part to a component 1202, such as a body or other structure of the vehicle. For example, the grommet 1200 can be used for attaching the trunk part 104 to the structural shear wall 604 (FIG. 6). As another example, the grommet 1200 can be used for attaching the trunk part 108 to the bumper beam 702 (FIG. 7). The grommet 1200 can be positioned in any of multiple locations of a vehicle trunk, including, but not limited to, at a rear wall, front wall, lateral wall, bottom wall, or a top wall, to name just a few examples.

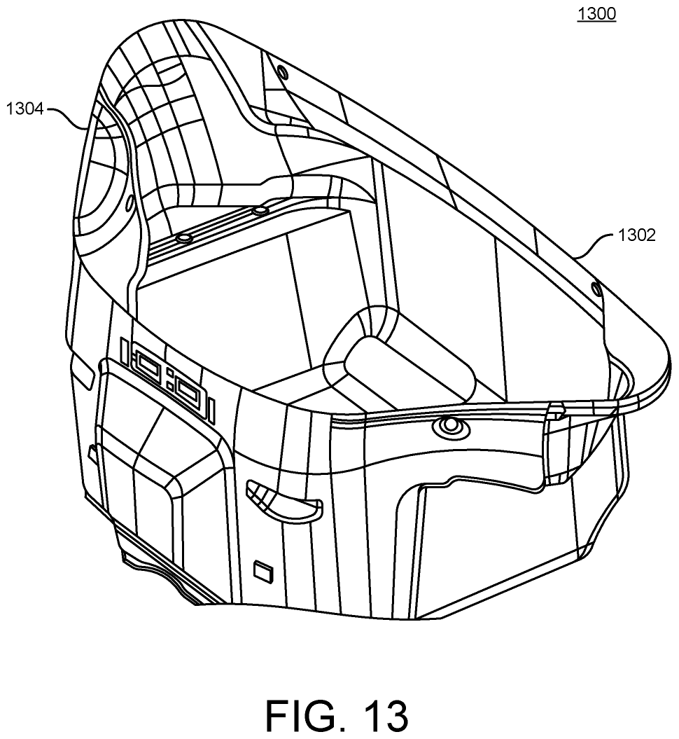

FIG. 13 shows a perspective view of an example of a carpet 1300 for a vehicle trunk. The carpet 1300 can be used with other examples described elsewhere herein. The carpet 1300 can be formed of synthetic and/or fibrous materials. The carpet 1300 can be used for lining an interior of a vehicle trunk. For example, the carpet 1300 can be configured for the interior 102 of the vehicle trunk 100 (e.g., FIG. 1). The carpet 1300 can include one or more carpet pieces. Here, the carpet 1300 includes a carpet piece 1302 and a carpet piece 1304. In some implementations, the carpet 1300 consists only of the carpet pieces 1302 and 1304.

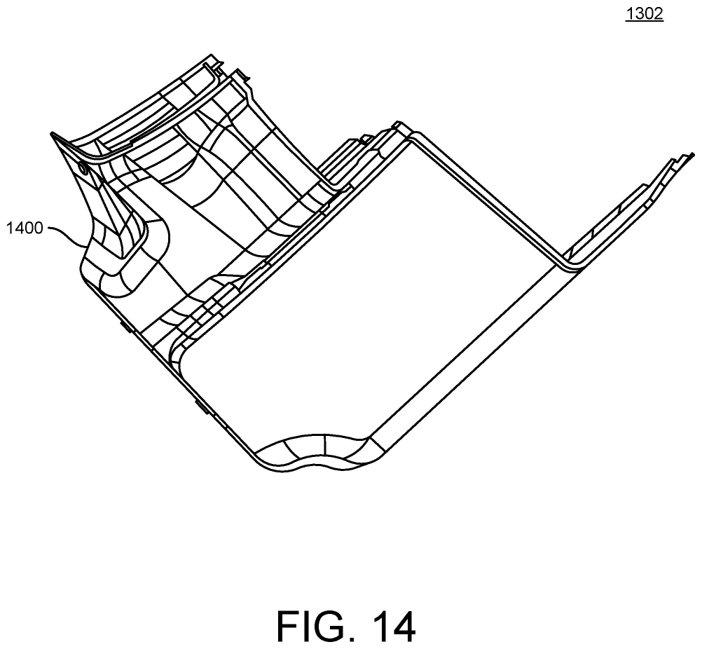

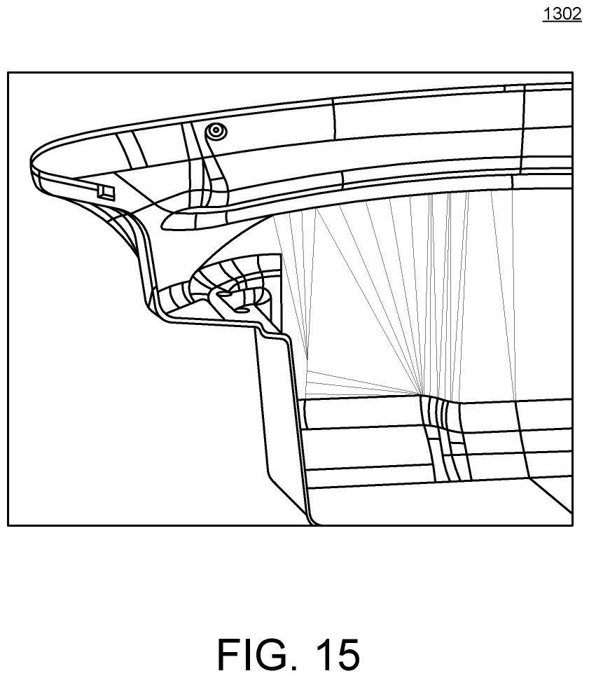

FIG. 14 shows a perspective view of an example of the carpet piece 1302 of the carpet 1300 of FIG. 13. The view is here from the opposite direction than in the previous illustration. FIG. 15 shows a partial perspective view of the carpet piece 1302 of FIG. 14. In some implementations, the carpet piece 1302 is molded to fit the interior of the vehicle trunk. For example, the carpet piece 1302 can be molded to have at least one undercut part 1400. In some implementations, the undercut part 1400 can be configured to fit within a corresponding portion of a trunk part. For example, the undercut part 1400 can be configured for the trunk part 104 (e.g., FIG. 1).

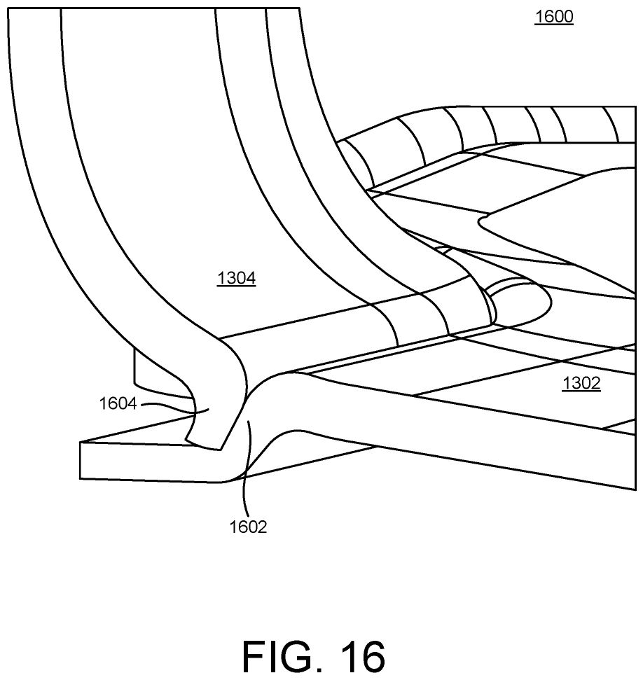

FIG. 16 shows an example cross section of a boundary 1600 of the carpet pieces 1302 and 1304 of the carpet 1300 of FIG. 13. The boundary 1600 can be used with other examples described elsewhere herein. The boundary 1600 is advantageous because it can be formed between two pieces (e.g., the carpet pieces 1302 and 1304) without adhesive and stitching. One of the carpet pieces, here the carpet piece 1302, can form a ridge 1602 where the boundary 1600 is to be formed. Another carpet piece, here the carpet piece 1304, can have an edge 1604 where the boundary 1600 is to be formed. The edge 1604 can be biasing against the ridge 1602, and the ridge 1602 can prevent the edge 1604 from moving forward in the biasing direction. The carpet piece 1304 can bias the edge 1604 in the direction toward the ridge 1602 due to how a remainder of the carpet piece 1304 is held in place. In some implementations, the adhesive element 112 (FIG. 1) can hold the carpet piece 1304 in a position where the edge 1604 is biased toward the ridge 1602. The adhesive element 112 can include any of multiple ways of attaching the carpet piece 1304 to the trunk part 104, including, but not limited to, a hook- and loop fastener.

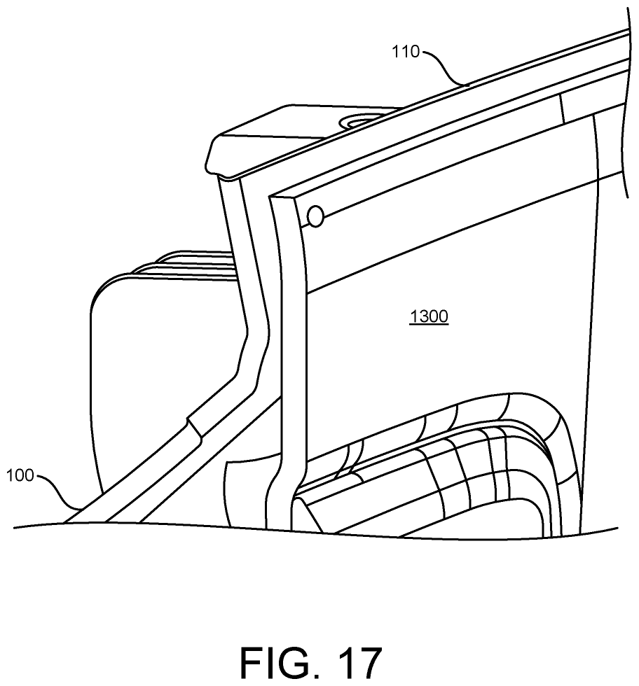

FIG. 17 shows an example cross section of a portion of the carpet 1300 of FIG. 13 and the vehicle trunk 100 of FIG. 1. In some implementations, the carpet piece 1304 (FIG. 13) of the carpet 1300 can here be attached to the trunk part 108 (e.g., FIG. 1) of the vehicle trunk 100. For example, structure can be attached to the rim 110 of the vehicle trunk 100 to ensure that the upper rim or edge of the carpet 1300 remains in place and does not dislocate.

The terms “substantially” and “about” used throughout this Specification are used to describe and account for small fluctuations, such as due to variations in processing. For example, they can refer to less than or equal to +5%, such as less than or equal to +2%, such as less than or equal to +1%, such as less than or equal to +0.5%, such as less than or equal to +0.2%, such as less than or equal to +0.1%, such as less than or equal to +0.05%. Also, when used herein, an indefinite article such as “a” or “an” means “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A vehicle trunk comprising:
a first trunk part forming at least a first wall of the vehicle trunk, the first trunk part including a thermoplastic elastomer material, wherein the first trunk part is at least partially collapsible to facilitate installation of the vehicle trunk into an undercut region of a vehicle; and
a second trunk part forming at least a second wall of the vehicle trunk, wherein the first and second trunk parts define an interior of the vehicle trunk, and wherein the second trunk part includes a fiber-reinforced polymer material.

2. The vehicle trunk of claim 1, wherein the second trunk part forms a closed loop that defines a main opening into the interior.

3. The vehicle trunk of claim 1, wherein the first wall of the vehicle trunk is at least one of a rear wall of the vehicle trunk or a front wall of the vehicle trunk.

4. The vehicle trunk of claim 3, wherein the first wall is configured to abut one of a structural shear wall of the vehicle, or a bumper beam of the vehicle, after the installation.

5. The vehicle trunk of claim 4, further comprising a grommet in the first trunk part, the grommet formed by the thermoplastic elastomer material and extending away from the interior, the grommet configured for attaching the first trunk part to the structural shear wall or the bumper beam.

6. The vehicle trunk of claim 1, wherein the first wall of the vehicle trunk includes two walls, the two walls facing each other and positioned at opposite sides of the interior.

7. The vehicle trunk of claim 6, wherein the two walls are a rear wall of the vehicle trunk and a front wall of the vehicle trunk, respectively.

8. The vehicle trunk of claim 1, wherein the first trunk part preexists the second trunk part, and wherein the second trunk part is formed by overmolding of the fiber-reinforced polymer material onto a part of the thermoplastic elastomer material of the first trunk part.

9. The vehicle trunk of claim 8, wherein the thermoplastic elastomer material includes an opening within the part of the first trunk part, and wherein the overmolding forms a rivet joint at the opening.

10. The vehicle trunk of claim 9, wherein the part of the thermoplastic elastomer material includes an edge of the first trunk part, and wherein the part of the thermoplastic elastomer material includes a taper in a direction that is substantially perpendicular to the edge.

11. The vehicle trunk of claim 10, wherein the part of the thermoplastic elastomer material further includes a strut adjacent the edge of the first trunk part, wherein the strut extends substantially in the direction of the taper, and wherein a top of the strut extends away from the fiber-reinforced polymer material.

12. The vehicle trunk of claim 11, wherein the part of the thermoplastic elastomer material includes multiple struts adjacent the edge of the first trunk part, wherein each of the multiple struts extends substantially in the direction of the taper, wherein the thermoplastic elastomer material includes multiple openings within the part of the first trunk part, wherein the overmolding forms multiple rivet joints, each of the multiple rivet joints formed at a respective one of the multiple openings.

13. The vehicle trunk of claim 12, wherein each of the multiple rivet joints is positioned between two adjacent struts of the multiple struts.

14. The vehicle trunk of claim 9, wherein the rivet joint comprises a head formed of the fiber-reinforced polymer material, the head positioned on an opposite side of the opening from a remainder of the fiber-reinforced polymer material.

15. The vehicle trunk of claim 14, wherein the first trunk part includes a recess in the thermoplastic elastomer material leading to the opening, and wherein the head is positioned in the recess.

16. The vehicle trunk of claim 1, wherein the second trunk part is configured for attachment of the vehicle trunk to the vehicle.

17. The vehicle trunk of claim 1, wherein the vehicle trunk is configured to be a front trunk of the vehicle.

18. The vehicle trunk of claim 17, wherein the front trunk is configured to be positioned ahead of a front motor of the vehicle.

19. The vehicle trunk of claim 1, further comprising a carpet that lines the interior of the vehicle trunk.

20. The vehicle trunk of claim 19, wherein the carpet consists of a first carpet piece and a second carpet piece, at least one of the first and second carpet pieces including an undercut part.

21. The vehicle trunk of claim 20, wherein a boundary of the first and second carpet pieces is formed without adhesive and stitching.

22. The vehicle trunk of claim 21, wherein the first carpet piece forms a ridge at the boundary, and wherein the second carpet piece is held in place at least in part by an edge of the second carpet piece biasing against the ridge.

23. The vehicle trunk of claim 22, further comprising adhesive positioned between the second carpet piece and at least one of the first and second trunk parts at a location other than at the boundary, wherein the edge of the second carpet piece biases against the ridge due to the adhesive being positioned between the second carpet piece and at least one of the first and second trunk parts.
